(19) United States
(12) Patent Application Publication
(10) Pub. No.: US 2009/0165119 A1
(43) Pub. Date: Jun. 25, 2009

(54) METHOD, APPARATUS AND COMPUTER PROGRAM PRODUCT FOR PROVIDING POWER CONTROL SECURITY FEATURES

(75) Inventor: SAI RAMANATH, Redmond, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/962,549

(22) Filed: Dec. 21, 2007

(51) Int. Cl. G06F 7/04

(52) U.S. Cl. 726/17

(57) ABSTRACT

A method, apparatus and computer program product are provided for power control security features. More particularly, the utilization of a supplemental power source can be permitted or prevented based on a comparison of access information to security information. In some embodiments, utilization of the supplemental power source can include the ability to charge a battery.

### TECHNOLOGICAL FIELD

Embodiments of the present invention relate generally to power control, and more particularly, relate to a method, apparatus and computer program for providing power control security features.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer. Current and future networking technologies continue to facilitate ease of information transfer and convenience to users by expanding the capabilities of mobile electronic devices. One area in which there is a demand to increase ease of information transfer relates to the delivery of services to a user of a mobile terminal.

Current mobile terminals not only provide local and long-distance voice communications, but also an increasing number of services are provided to mobile terminal users. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or requests made by the user (e.g., content searching, mapping or routing services, etc.). The services may be provided from a network server or other network device, or even from the mobile terminal such as, for example, a mobile telephone, a mobile television, a mobile gaming system, etc. Some of these services may be no additional cost services, i.e. services that are included as device functionality or included in an appropriate rate plan, while many others may be additional cost services that may appear on a monthly billing statement. Often additional cost services can be purchased simply by selecting the service from within the user interface of the mobile terminal. The associated charges will then appear on a monthly statement.

Additionally, due to the ubiquitous nature of mobile communication devices, people of all walks of life are now utilizing mobile terminals to communicate with other individuals or contacts and/or to share information, media and other content. Accordingly, users are more frequently choosing to store and/or share personal or confidential information in the memory of mobile devices. Accordingly, it is increasingly common for individuals to rely heavily on mobile communication devices for enriching their lives with entertainment, socialization and even work related activities.

However, as users become increasingly dependant upon mobile communications devices in their daily lives, a lost or stolen mobile telephone can become a significant security event. A thief may use a stolen mobile device to purchase any number of products or services through the mobile terminal which can result in substantial fees for an unknowing victim. Further, a thief may gain access to the sensitive information stored on the mobile terminal. In this regard, even after a victim becomes aware that the mobile terminal is missing and stops communications service to the mobile terminal, access to sensitive information may still remain. As such, an increased potential for damage to the owner of the mobile terminal can result, putting the owner at risk to crimes such as identity theft.

Accordingly, it may be advantageous to limit the security risk posed to owners of lost or stolen mobile terminals. In this regard, owners of mobile terminals may enjoy additional protection of having limited exposure to fraudulent charges, and publication of sensitive information.

### BRIEF SUMMARY

A method, apparatus and computer program product are therefore provided for limiting the risk associated with lost or stolen mobile terminals by implementing power control security features. Embodiments of the invention can comprise detecting a supplemental power source, and receiving access information. Based on a comparison of the access information and predefined security information, utilization of the supplemental power source may be permitted.

In some embodiments, utilization of the supplemental power source can comprise charging a battery. Further, in some embodiments, utilization of non-power controlling functionality may be prevented based on a result of comparing the access information with security information.

Additionally, according to some embodiments, access information can be received as data acquired from alpha-numeric characters. According to some embodiments, access information can be received as data acquired from an eye scan. In other embodiments, access information can be received as data acquired from a fingerprint. In still other embodiments, access information can be received as data acquired from voice commands.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an embodiment of the present invention; and

FIG. 2 is a flow chart of a method of providing power control security features an exemplary of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

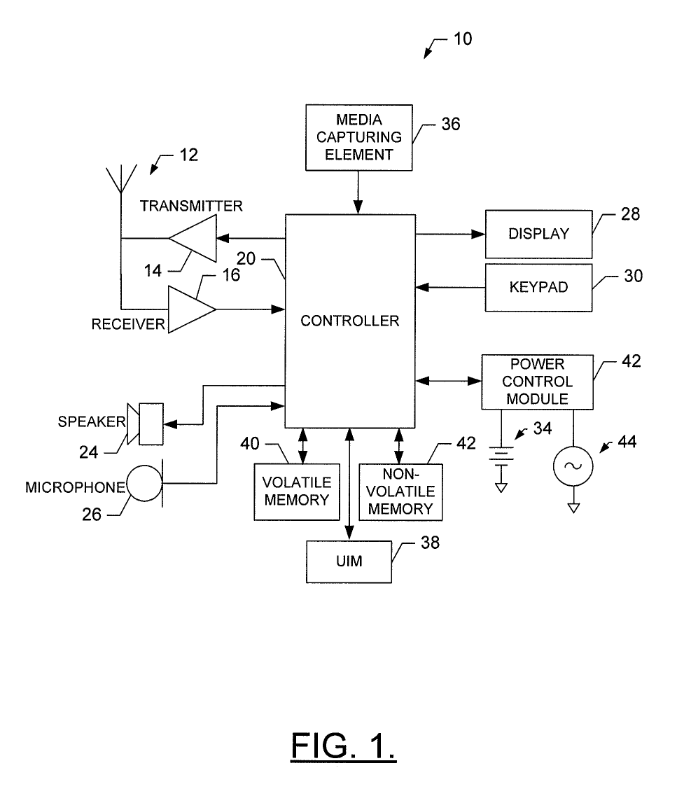

FIG. 1 illustrates a block diagram of a mobile terminal 10 that may benefit from embodiments of the present invention. It should be understood, however, that a mobile telephone as illustrated and hereinafter described is merely illustrative of one type of mobile terminal that may benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

Embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a processor, such as a controller 20 or other processing element or computing device, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes means, such as circuitry, desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface.

The mobile terminal 10 further includes a battery 34, such as a vibrating battery pack, for powering various circuits that are required to operate the mobile terminal 10, as well as optionally providing mechanical vibration as a detectable output. Battery 34 can provide power directly to mobile terminal 10 or indirectly through power control module 37. Additionally, mobile terminal 10 can be powered through power control module 37 by supplemental power source 44. Supplemental power source 44 can be any power source that is not the primary power source of mobile terminal 10. Further, supplemental power source 44 can take various forms including, but not limited to a power adapter electrically connected to a wall outlet or other electrical outlet, in for example, a vehicle or airplane. In this regard, supplemental power source 44 can be removable from mobile terminal 10 to permit unfettered mobility of mobile terminal 10. When supplemental power source 44 is removed, or disconnected, either physically or electrically, for instance through functionality in power control module 37, battery 34 can be the sole power source of mobile terminal 10.

In some embodiments, the mobile terminal 10 can include a media capturing element 36, such as a camera, video and/or audio module, in communication with the controller 20. The media capturing element 36 may be any means for capturing an image, video and/or audio for storage, display or transmission. For example, in an embodiment in which the media capturing element is a camera module, the camera module may include a digital camera capable of forming a digital image file from an image captured by camera module. As such, the camera module includes all hardware, such as a lens or other optical component(s), and software necessary for creating a digital image file from a captured image. The camera module may also include all hardware, such as a lens or other optical component(s), and software necessary to provide image zooming functionality. Image zooming functionality can include the ability to magnify or de-magnify an image prior to or subsequent to capturing an image. Alternatively, the camera module may include only the hardware needed to view an image, while a memory device of the mobile terminal 10 stores instructions for execution by the controller 20 in the form of software necessary to create a digital image file from a captured image. In an exemplary embodiment, the camera module may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard or other format.

In some embodiments, media capturing element 36 can be used to implement various biometric technologies to identify a user. For example, media capturing element 36 can perform eye recognition or fingerprint recognition. In some embodiments, media capturing element 36 can be a camera module, as discussed above, to implement eye recognition or fingerprint recognition. For eye recognition, media capture element 36 can implement iris recognition or retinal scanning technologies. Similarly, for fingerprint recognition media capturing element 36 can use various means, such as optical fingerprint imaging, ultrasonic fingerprint imaging, or capacitance-type imaging to acquire identification information regarding a target individual. As such, media capturing element 36 can include all hardware and software necessary for implementing biometric identification. Alternatively, media capturing element 36 may operate in conjunction with controller 20 to implement biometric identification. In another embodiment, the media capturing element 36 may further include a processing element such as a co-processor which assists the controller 20 in processing biometric data.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

In some embodiments, mobile terminal 10 can also include a power control module 37, in communication with the controller 20. The power control module 37 may be any means, hardware or software for controlling power within mobile terminal 10. In some embodiments, power control module 37 can be a software implementation operating on controller 20 of mobile terminal 10. As such, power control module 37 can include all hardware, and software necessary for controlling power within mobile terminal 10. Alternatively, in some embodiments, power control module 37 may include only the hardware needed to permit or prevent the use of supplemental power source 44 by mobile terminal 10, while a memory device of the mobile terminal 10 stores instructions for execution by the controller 20 in the form of software necessary to control power within mobile terminal 10. In an example embodiment, power control module 37 may further include a processing element such as a co-processor which assists the controller 20 in controlling power. In some embodiments, power control module 37 can detect whether a supplemental power source 44 is connected to mobile terminal 10. In some embodiments, power control module 37 can permit or prevent the charging of battery 34 using supplemental power source 44. Similarly, in some embodiments, power control module 37 can permit or prevent the use of supplemental power source 44 for powering predetermined functionality of mobile terminal 10.

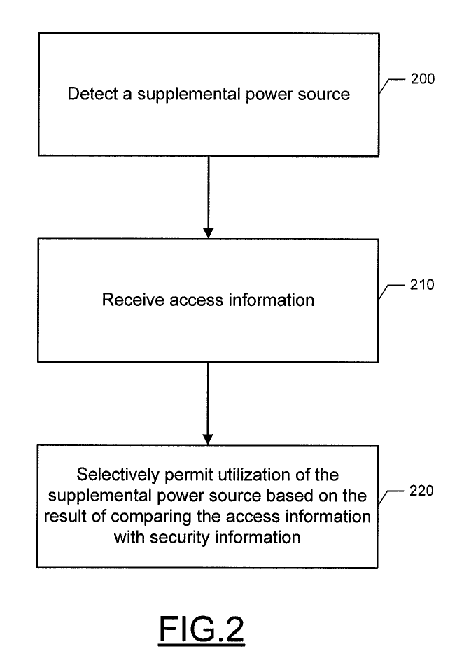

FIG. 2 depicts a flow chart of a method of implementing power control security features according to various embodiments. The flow chart of FIG. 2 can include detecting a supplemental power source at 200, receiving access information at 210, and permitting the utilization of the supplemental power source based on the result of comparing the access information with security information at 220. Further, with regard to the method of FIG. 2, in some embodiments and in situations where mobile terminal 10 cannot use power provided by a battery, for example, due to the battery being sufficiently discharged, mobile terminal 10 can use the power provided by a connected supplemental power source to implement the method of FIG. 2. However, in some embodiments, in situations where the battery cannot provide power to operate mobile terminal 10, the functionality of mobile terminal 10 can be limited to only the functionality described with respect to FIG. 2.

At 200, a supplemental power source can be detected. A supplemental power source, such as supplemental power source 44 of FIG. 1, can be detected when it is electrically connected to mobile terminal 10. A supplemental power source can be detected by controller 20, power module 44, or other means. For example, mobile terminal 10 may be disconnected from a supplemental power source and can rely solely on battery 34 for power. In order to permit the charging the battery 34, or for various other reasons, mobile terminal 10 can be connected to a supplemental power source, such as supplemental power source 44. Upon connecting a supplemental power source to mobile terminal 10, the supplemental power source can be detected.

At 210, access information can be received. Access information can be received by various means, including, but not limited to controller 20 of mobile terminal 10. In some embodiments, receiving access information can also include requesting the access information via an output device, output module or other means, including but not limited to display 28 or speaker 24. In response to the request, a user can provide access information via various input devices, such as, but not limited to, media capturing element 36, keypad 30, microphone 26, or a touch display. Access information can be provided by a user and acquired by mobile terminal 10 using various means. For instance, in some embodiments, a user can provide alpha-numeric characters in the form of a code, pin or password as access information via, for example, keypad 30 or a touch display. In other embodiments, a user can provide access information from an image of a user's fingerprint or eye via media capturing element 36. In some additional embodiments, a user can provide access information through the use of voice commands, such as, speaking a code, pin, password or pass-phrase. In some embodiments, the voice commends can be acquired via microphone 26. In some embodiments, the access information can be converted into digital data.

At 220, utilization of the detected supplemental power source can be permitted based on the result of comparing the access information with security information. Utilization of the detected supplemental power source can be permitted by various means, including but not limited to power control module 37 or controller 20. In some embodiments, prior to performing the comparison, security information can be acquired and stored on memory within mobile terminal 10. In some embodiments, security information can be acquired and stored during a setup procedure for mobile terminal 10. Security information can be provided by a user and acquired by mobile terminal 10 using various means. For instance, in some embodiments, a user can provide alpha-numeric characters in the form of a code, pin or password as security information via, for example, keypad 30 or a touch display. In other embodiments, a user can provide security information from an image of a user's fingerprint or eye via media capturing element 36. In some additional embodiments, a user can provide security information through the use of voice commands, such as, speaking a code, pin, password or pass-phrase. In some embodiments, the voice commends can be acquired via microphone 26. In some embodiments, the security information can be converted into digital data.

Accordingly, the predetermined security information can be compared to the access information to determine a result. The comparison can be implemented by controller 20, power control module 37 or other means. In some embodiments, the result may be a successful result indicating a match between the security information and the access information, and a result indicating a match may permit the utilization of the supplemental power source. In some embodiments, a successful result may be a near match within a predetermined error rate which can permit utilization of the supplemental power source by controller 20 or power control module 37. For example, if access information describing a fingerprint and security information describing a fingerprint are compared, an error rate may be introduced such that an identical match is not required, since various unknowns can impact fingerprint recognition. In this regard, any known means of fingerprint recognition, eye recognition, or voice recognition and comparison can be used to determine a result. Likewise, if the result of the comparison is not an identical match or, in cases where an error rate is used, a near match, the result can be unsuccessful and utilization of the supplemental power source can be prevented. Further, in some embodiments, utilization of the supplemental power source can be prevented as an initial condition and prevention of the utilization of the supplemental power source can continue until a successful result is provided.

If as a result of the comparison, utilization of the supplemental power source is prevented, by controller 20, power control module 37 or other means, various functionality of mobile terminal 10 can be prevented by power control module 37, controller 20, or other means. For instance, in some embodiments, if utilization of the supplemental power source is prevented, the supplemental power source may be prevented from charging a battery. Further, in some embodiments, if utilization of the supplemental power source is prevented, power control module 37, or controller 20 may limit the functionality of mobile terminal 10 to only power controlling functionality, such as, the functionality associated with FIG. 2, that is, detecting a supplemental power source, receiving access information and permitting utilization of the supplemental power source based on the result of comparing the access information with security information. In this regard, all other functionality can be considered non-power controlling functionality.

If as a result of the comparison, utilization of the supplemental power source is permitted, various functionality of mobile terminal 10 can be enabled by power control module 37 or controller 20. For example, when utilization of the supplemental power source is permitted, the supplemental power source may be permitted to charge a battery. Further, in some embodiments, if utilization of the supplemental power source is permitted, power control module 37 or controller 20 may permit the supplemental power source to power all functionality of mobile terminal 10 and permit the utilization of all functionality of mobile terminal 10.

As a result, various embodiments can prevent the charging of a battery in mobile terminal 10, in particular the controller, when no access information is received or improper access information is received. This can prevent a mobile terminal from being used longer than the life of the battery when the mobile terminal is stolen or lost. Such functionality can limit the risk associated with losing a mobile terminal.

According to one aspect of the present invention, the electronic device, such as mobile terminal 10, which implements embodiments of the present invention generally operates under control of a computer program product. The computer program product for performing the methods of embodiments of the present invention includes a computer-readable storage medium and computer-readable program code portions, such as a series of computer instructions, embodied in the computer-readable storage medium.

In this regard, FIG. 2 is a flowchart of method, apparatus and program products according to exemplary embodiments of the present invention. It will be understood that each block or step of the flowchart, and combinations of blocks in the flowchart, can be implemented by computer program instructions. These computer program instructions may be loaded onto a computer or other programmable apparatus, such as controller 20, to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
detecting a supplemental power source,
receiving access information, and
selectively permitting utilization of the supplemental power source based on a result of comparing the access information with security information.

2. The method of claim 1 wherein selectively permitting utilization of the supplemental power source further comprises charging a battery from the supplemental power source if the result of comparing the access information with the security information is successful.

3. The method of claim 1 further comprising preventing utilization of non-power controlling functionality if the result of comparing the access information with the security information is unsuccessful.

4. The method of claim 1 further comprising limiting functionality to detecting a supplemental power source, receiving access information, and comparing the access information with security information, if the result of comparing the access information with the security information is unsuccessful.

5. The method of claim 1 wherein receiving access information further comprises receiving access information comprising data acquired from alpha-numeric characters.

6. The method of claim 1 wherein receiving access information further comprises receiving access information comprising data acquired from an eye scan.

7. The method of claim 1 wherein receiving access information further comprises receiving access information comprising data acquired from a fingerprint.

8. The method of claim 1 wherein receiving access information further comprises receiving access information comprising data acquired from voice commands.

9. An apparatus comprising a processor configured to
detect a supplemental power source,
receive access information, and
selectively permit utilization of the supplemental power source based on the result of comparing the access information with security information.

9. The apparatus of claim 9 wherein the processor is further configured to permit utilization of a supplemental power source by permitting the charging of a battery from the supplemental power source if the result of comparing the access information with the security information is successful.

10. The apparatus of claim 9 wherein the processor is further configured to prevent utilization of non-power controlling functionality if the result of comparing the access information with the security information is unsuccessful.

11. The apparatus of claim 9 wherein the processor is further configured to limit functionality to detecting a supplemental power source, receiving access information, and comparing the access information with security information, if the result of comparing the access information with the security information is unsuccessful.

12. The apparatus of claim 9 wherein the processor is further configured to receive access information comprising data acquired from one of alpha-numeric characters or voice commands.

13. The apparatus of claim 9 wherein the processor is further configured to receive access information comprising data acquired from an eye scan.

14. The apparatus of claim 9 wherein the processor is further configured to receive access information comprising data acquired from a fingerprint.

15. A computer-readable storage medium having computer-readable program code portions stored therein, the computer-readable program code portions comprising:
a first executable portion configured to detect a supplemental power source;
a second executable portion configured to receive access information; and
a third executable portion configured to selectively permit utilization of the supplemental power source based on the result of comparing the access information with security information.

16. The computer-readable storage medium of claim 15 wherein the third executable portion is further configured to permit utilization of a supplemental power source by permitting the charging of a battery from the supplemental power source if the result of comparing the access information with the security information is successful.

17. The computer-readable storage medium of claim 15 further comprising a fourth executable portion configured to prevent utilization of non-power controlling functionality based on a result of comparing the access information with security information.

18. The computer-readable storage medium of claim 15 further comprising a fourth executable portion configured to limit functionality to detecting a supplemental power source, receiving access information, and comparing the access information with security information, if the result of comparing the access information with the security information is unsuccessful.

19. The computer-readable storage medium of claim 15 wherein the second executable portion is further configured to receive access information comprising data acquired from alpha-numeric characters.

20. The computer-readable storage medium of claim 15 wherein the second executable portion is further configured to receive access information comprising data acquired from an eye scan.

21. The computer-readable storage medium of claim 15 wherein the second executable portion is further configured to receive access information comprising data acquired from a fingerprint.

22. The computer-readable storage medium of claim 15 wherein the second executable portion is further configured to receive access information comprising data acquired from voice commands.

23. An apparatus comprising:
means for detecting a supplemental power source,
means for receiving access information, and
means for selectively permitting utilization of the supplemental power source based on a result of comparing the access information with security information.

24. The apparatus of claim 23 wherein the means for selectively permitting utilization of the supplemental power source further comprises charging a battery from the supplemental power source if the result of comparing the access information with the security information is successful.

25. The apparatus of claim 23 further comprising means for preventing utilization of non-power controlling functionality based on a result of comparing the access information with security information if the result of comparing the access information with the security information is unsuccessful.
